(19) United States
(12) Patent Application Publication
(10) Pub. No.: US 2021/0370206 A1
(43) Pub. Date: Dec. 2, 2021

(54) AN AIR FILTER

(71) Applicant: Enzo Fiocchi, Riga (LV)

(72) Inventor: Enzo Fiocchi, Riga (LV)

(21) Appl. No.: 16/978,783

(22) PCT Filed: Mar. 8, 2018
(86) PCT No.: PCT/IB2018/051533

§ 371 Date: Sep. 8, 2020

(51) Int. Cl. B01D 39/08

(52) U.S. Cl. CPC B01D 39/083; B01D 2239/025; B01D 46/521; B01D 2239/1291; B01D 2239/065

(57) ABSTRACT

The present invention relates to high performance air filters made of a woven fabric and nanofiber filaments. An air filter, comprising a frame assembly (10), a filter assembly (11) attached to the frame assembly (10). The filter assembly (11) further comprises a woven filtering fabric (1) disposed within the frame assembly (10) and comprising calibrated woven strands, and a layer of nanofiber filaments (2) disposed on one side of the woven filtering fabric (1) forming a web of the nanofiber filaments (2) an open area between the strands of the woven filtering fabric (1).

### FIELD OF THE INVENTION

The present invention relates to high performance air filters made of a woven fabric and nanofiber filaments.

### BACKGROUND OF THE INVENTION

The prior art discloses various air filters where air filtration is carried out by filter comprising nonwoven fabrics and an overlay of different nanofiber filaments. The following air filter has multiple drawbacks if intended for use in high performance air filtration. One of the drawbacks is that the aforementioned filters have considerable pressure drop decreasing its performance.

### SUMMARY OF THE INVENTION

The aim of the invention is to design a high performance air filter that would not have drawbacks of nonwoven fabric filters as well as be more effective than woven filters known from a prior art.

The aim of the invention is achieved by design of an air filter comprising a woven fabric with an overlay of nanofiber filaments. A layer of nanofiber filaments has been applied over one side of a polyester woven fabric in order to filter also the smallest sizes of any contaminant and reducing the pressure drops to the minimum. The woven filtering fabric comprises woven strands with calibrated spacing so that performance of the filter may be adapted to the necessary filtration. The result is an air filter with very high filtration and small pressure drop.

An important aspect of the invention is the utility of such microfiber or nanofiber materials formed into a filter structure. In such a structure, the fine fiber materials of the invention are formed on and adhered to a filter substrate.

The polyester woven fabric with nanofiber filaments may be protected by protective filtering fabric. The protective filtering fabric may be non-woven or woven fabric, and may be made of any kind of fabric, preferably polyester or nylon. The protective filtering fabric is arranged on that side of the woven filtering fabric where the nanofiber filaments are laid, therefore protecting these nanofiber filaments from damage from large particles to be filtered. The protective filtering fabric is arranged in front of the nanofiber filaments in a direction of an air flow.

Thanks to protective fabric the nanofibers are protected from the big sizes particles that moved under the air pressure can damage the nanoparticles reducing the filtering power and at the same time the aforementioned feature prevents the creation of a dust cake inside the nanofiber web prolonging the filter life and reducing the pressure drop.

In one embodiment, the spacing of the strands of the woven filtering fabric is 55 micrometres or microns. The length of overlaid nanofiber filaments is 0.015 micrometres or microns. The spacing of the strands of the protective filtering fabric is 40 micrometres or microns, preventing any contamination that could damage the nanofibers. In this embodiment all the contaminants over 40 microns size will be stopped by the protective filtering fabric, all the smallest particles of contaminants (under 40 microns in this case) will be stopped by the nanofiber web or the woven filtering fabric with nanofiber filaments. In this way, the nanofibers will be protected from the big sizes particles that moving under the air pressure can damage them reducing the filtering power and at the same time, it prevents the creation of a dust cake inside the nanofiber web prolonging the filter life and reducing the pressure drop.

In another embodiment the filter assembly further comprises a mesh arranged in front of the protective filtering fabric in a direction of an air flow, and another mesh arranged on a back of the woven filtering fabric in a direction of an air flow, in result of which a sandwiched air filter assembly is formed.

Changing the sizes of the woven fabrics and density of the nanofibers and, when needed, sizes of the protection fabric of the nanofibers it is possible to create a calculated very high airflow and a calculated high filtration.

### BRIEF DESCRIPTION OF THE DRAWINGS

The following invention is described in more detail using the following figures:

FIG. 1 illustrates an air filter comprising a woven filtering fabric 1 with woven strands with calibrated spacing 4 and nanofiber filaments 2 disposed on the woven filtering fabric 1.

FIG. 2 illustrates a schematic of an air filter comprising a woven filtering fabric 1, nanofiber filaments 2 and protective filtering fabric 3.

FIG. 3 illustrates an air filter in a cross-section comprising a frame assembly 10 and a filter assembly 11.

FIG. 4 illustrates the air filter in a cross-section shown in FIG. 3.

FIG. 5 illustrates a filter assembly 11 in assembly with meshes 6 from both sides.

### DETAILED DESCRIPTION OF THE INVENTION

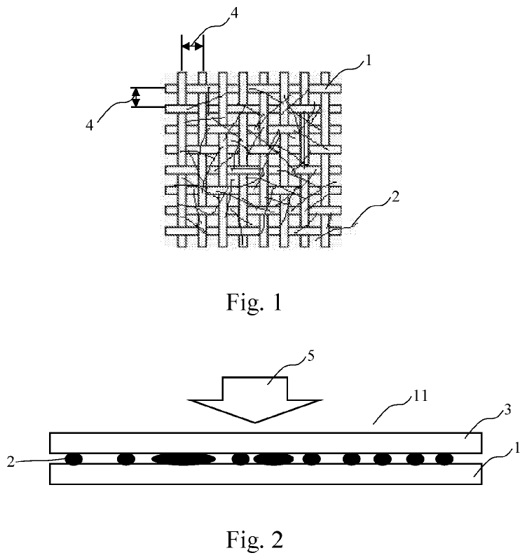

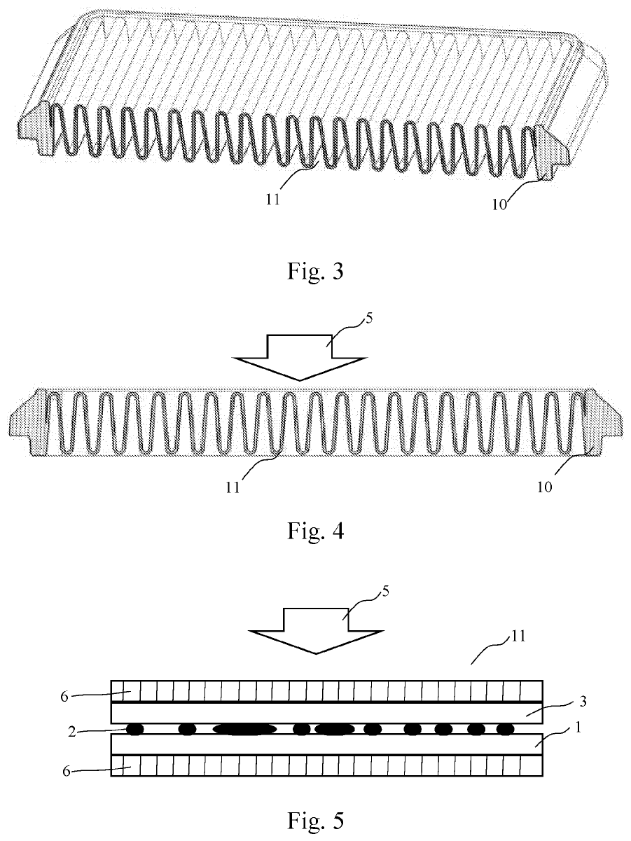

FIG. 1 shows a woven filtering fabric 1 with woven strands with calibrated spacing 4 and nanofiber filaments 2 randomly disposed on the woven filtering fabric 1. The following woven filtering fabric 1 is further accompanied by a protective filtering fabric 3 (see FIG. 2). The protective filtering fabric 3 is disposed on the side of the woven filtering fabric 1 where nanofiber filaments 2 are disposed and in front of the woven filtering fabric 3 in a direction of an air flow 5. Moreover, the nanofiber filaments 2 are disposed or layered only on one side of the woven filtering fabric 1. The following air filter comprising sandwiched woven filtering fabric 1, nanofiber filaments 2 and protective filtering fabric 3 is covered from both sides with a mesh 6 (see FIG. 5). The air filter comprising layers is the following order—the mesh 6, the woven filtering fabric 1, the nanofiber filaments 2, the protective filtering fabric 3 and mesh 6—is bended and installed in a frame assembly 10 (see FIGS. 3 and 4). At the end, an air filter is formed ready to be installed in a vehicle air filtration system.

Given invention is not restricted by embodiments of invention described herein. Those skilled in the art can change or modify given embodiments without departing from the spirit and scope of the invention.

1. An air filter, comprising:
a frame assembly (10);
a filter assembly (11) attached to the frame assembly (10), wherein the filter assembly (11) further comprises:
a woven filtering fabric (1) disposed within the frame assembly (10) and comprising calibrated woven strands; and
a layer of nanofiber filaments (2) disposed on one side of the woven filtering fabric (1) forming a web of the nanofiber filaments (2) on open area between the strands of the woven filtering fabric (1),
wherein the filter assembly (11) further comprises a protective filtering fabric (3) arranged on a side of the woven filtering fabric (1) where the nanofiber filaments (2) are disposed.

2. (canceled)

3. The air filter according to claim 1, wherein a woven filtering fabric (1) is a polyester woven filtering fabric (1).

4. The air filter according to claim 1, wherein a woven filtering fabric (1) is a nylon woven filtering fabric (1).

5. The air filter according to, claim 4, wherein a spacing (4) of strands of the woven filtering fabric (1) is 55 microns and a spacing (4) of strands of the protective filtering fabric (3) is 40 microns.

6. The air filter according to claim 1, wherein the filter assembly (11) further comprises a mesh (6) arranged in front of the protective filtering fabric (3) in a direction of an air flow (5).

7. The air filter according to claim 5, wherein the filter assembly (11) further comprises another mesh (6) arranged on a back of the woven filtering fabric (1) in a direction of an air flow (5), in result of which a sandwiched air filter assembly (11) is formed.

8. The air filter according to claim 1, wherein the filter assembly (11) further comprises:
a protective filtering fabric (3) arranged on a side of the woven filtering fabric (1) where the nanofiber filaments (2) are disposed;
a mesh (6) arranged in front of the protective filtering fabric (3) in a direction of an air flow (5); and
a mesh (6) arranged in front of the protective filtering fabric (3) in a direction of an air flow (5) a frame assembly (10),
wherein the a spacing (4) of strands of the woven filtering fabric (1) is 55 microns and a spacing (4) of strands of the protective filtering fabric (3) is 40 microns.
